(19) United States
(12) Patent Application Publication
(10) Pub. No.: US 2018/0218385 A1
(43) Pub. Date: Aug. 2, 2018

(54) PSYCHOGRAPHIC DECISION SYSTEM

(71) Applicant: APOLLO ENTERPRISE SOLUTIONS, LTD., Long Beach, CA (US)

(72) Inventor: Adrian Gluck, Beverly Hills, CA (US)

(73) Assignee: APOLLO ENTERPRISE SOLUTIONS, LTD., Long Beach, CA (US)

(21) Appl. No.: 15/736,517

(22) PCT Filed: Jun. 16, 2016
(86) PCT No.: PCT/US2016/037932

§ 371 Date: Dec. 14, 2017

Related U.S. Application Data
(60) Provisional application No. 62/180,949, filed on Jun. 17, 2015.

(51) Int. Cl. G06Q 30/02; G06F 17/30

(52) U.S. Cl. CPC G06Q 30/0204; G06F 17/30867; G06F 17/30554

(57) ABSTRACT

A system for serving electronic communications facilitating decision making by a user is provided. The system includes a computer store containing emotional wording, adjectives, sensations, industry phrases, industry communications, graphics, and emotional factors and triggers usable for inclusion in an electronic communication (i) where the electronic communication is configured to include text and graphics using a template; and (ii) where the electronic communication includes a call for action to be taken by the user. The system further includes a computer processor coupled to the computer store and programmed to: (i) receive a profile of the user's demographic profile; (ii) map out possible user journeys and actions; (iii) identify actions to be influenced along each journey; (iv) determine a set of emotional triggers for each action; (v) retrieve industry phrases and graphics for each emotional trigger; and (vi) create graphics and journey page layouts for transmission in the electronic communication.

This application claims priority to earlier filed U.S. Provisional Application Ser. No. 62/180,949, filed Jun. 17, 2015, which is related to PCT Application PCT/US13/67055, filed Oct. 28, 2013, entitled “SYSTEM AND METHOD FOR ENHANCING SELECTION OF ITEMS,” inventor Adrian Gluck, the entirety of both of which is incorporated herein by reference.

### BACKGROUND OF THE INVENTION

### Field of the Invention

The present invention relates generally to computing devices and systems for efficiently enhancing choices, decisions, and selections made by persons or entities.

### Description of the Related Art

In the internet age, computing devices are constantly employed to make decisions regarding items and situations—blue or black, Company X or Company Y, big or small, highly rated or low cost, and so forth. People are generally driven by their pursuit of self-interest, with their individual choices and selections providing information and measurements useful in revealing their preferences. If at the end of the day you use your computing device to select an employer as company Z located in city X based on a review of 27 positive employee recommendations and three negative recommendations, and you choose company Z rather than company W after being on company Z's web site for three hours and company W's web site for 45 minutes. As a result, you have indicated a number of quantitative values and a great deal of information about how you selected your potential employer.

Current systems typically provide selections based either on predetermined arrangements, such as static arrangements, or arrangements selectively ordered in some manner, such as most popular, lowest price, highest likelihood of matching the phrase entered, or some other arrangement. However, certain people are motivated by ratings, while others are motivated by perceived costs, while still others are motivated by the ability of the selection to satisfy a particular, unspoken need. It can be difficult to place the right selection in front of the right individual, particularly when only a limited number, say three or four, selections are presented on a single screen to a user. With the limited amount of time people spend on web sites, it would be beneficial to present each user with a set of choices directed to facilitate selections most closely matching his or her interests, wants, and/or needs in a relatively rapid yet controlled manner.

In light of the above, it would be desirable to provide a computing device that improves online selections by individuals of items over systems and devices previously employed for such purposes.

### SUMMARY OF THE INVENTION

According to one aspect of the present design, there is provided a system useful in a provider serving electronic communications facilitating decision making by a user. The system comprises a computer store arrangement containing emotional wording, adjectives, sensations, industry phrases, industry communications, industry graphics data, and universal emotional factors and triggers usable for inclusion in at least one electronic communication (i) wherein the at least one electronic communication is configured to include text and graphics using an electronic communication template; and (ii) wherein the at least one electronic communication includes at least one call for action to be taken by the user selectable by the user to facilitate the user making a decision. The system further includes a computer processor coupled to the computer store and programmed to: (i) receive a profile of the user's demographic profile; (ii) map out possible user journeys and actions; (iii) identify actions to be influenced along each journey; (iv) determine a set of emotional triggers for each action; (v) retrieve industry phrases and industry graphics for each emotional trigger; and (vi) create graphics and journey page layouts. The computer processor transmits the graphics and journey page layouts created by the computer processor in the at least one electronic communication.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 illustrates a computer system for use in accordance with one embodiment of the present design;

FIG. 2A illustrates the decision making process;

FIG. 2B represents the overall workflow of the present design;

FIG. 3 shows the various elements considered and/or stored in the computer stores of the present design;

FIG. 4 is an Action zone map;

FIG. 5 illustrates one embodiment of the overall design;

FIG. 6 is a representative screen for defining a cohort demographic profile;

FIG. 7 is a representative screen defining the user journey or campaign and the actions associated;

FIG. 8 shows selectable actions to be influenced along the journey;

FIG. 9 is a representative screen showing the emotional triggers;

FIG. 10 is a representative screen showing industry phrases;

FIG. 11 is a representative screen showing industry graphics parameters;

FIG. 12 illustrates one complete communication prepared by the present system;

FIG. 13 shows the relationship between a communication and the emotional triggers used to create the communication;

FIG. 14 is a first treatment used in a particular journey;

FIG. 15 is a second treatment used in the particular journey of FIG. 14, representing an alternate treatment based on different system determinations; and

FIG. 16 is an alternate representation of the present system.

### DETAILED DESCRIPTION OF THE INVENTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

In general, the present design includes a system for selecting emotional triggers for persons in different demographics, selecting an appropriate story the user can relate to, where the story triggers an emotion and the emotion triggers a heuristic, the user considers the proof and decides to take action. The system may be employed to adjust the emotional triggers and the story. A heuristic is any approach to problem solving, learning, or discovery that employs a practical methodology not guaranteed to be optimal or perfect, but sufficient for the immediate goals. Where finding an optimal solution is impossible or impractical, heuristic methods can be used to speed up the process of finding a satisfactory solution. Heuristics can be mental shortcuts that ease the cognitive load of making a decision. Examples of this method include using a rule of thumb, an educated guess, an intuitive judgment, stereotyping, profiling, or common sense. More precisely, heuristics are strategies using readily accessible, though loosely applicable, information to control problem solving in human beings and machines.

The system determines a number of communications to provide to the user for the express purpose of aiding the user in making a decision. To that end, the system identifies the industry, determines the user's or user cohort's demographic profile, maps out journeys and Actions for the user, determines and may recommend a set of emotional triggers for each Action zone, determines and/or retrieves industry phrases, based on industry communications, emotions, adjectives, and sensations contained in various data stores or databases, obtains industry graphics to support emotional triggers, creates graphics and journey page layouts, finalizes the journey treatment, and transmits a set of communications to the user in a preferred electronic format. The system is set to analyze the user's actions and may prepare reports and/or modify words, phrases, graphics, layouts, actions, and other relevant materials.

As used herein, the term “industry” is employed and is intended to be general in nature to mean the setting or milieu of the particular decision being made. For example, in a technology area, communications, triggers, and so forth relevant to the technology industry may apply, where in a simple game setting, i.e. deciding which game to play, communications, triggers, and so forth relating to the game setting or milieu may be contemplated and communications appropriate for such a setting or milieu employed. Additionally, the description herein uses phrases such as “journey” or “campaign.” These words and other similar words are also intended broadly, in particular to mean a collection of acts (sometimes called Actions herein) that may occur over time in a concerted effort to assist a user to reach a decision in a particular instance.

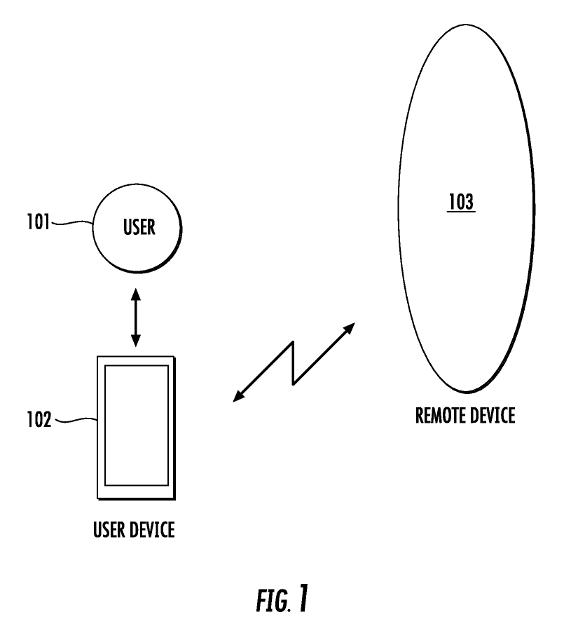

One aspect of the present system is illustrated in FIG. 1. From FIG. 1, user 101 interfaces with user device 102 which may collect information about the user and transmit that information to remote device 103. Remote device 103 is a specialized arrangement that offers online computational functionality, including but not limited to a server or server arrangement, the Internet “cloud,” or other devices. Other user devices may be employed, and each user device offers internet connectivity, whether by wire or wireless connection or some combination or any other means known to those skilled in the art, to remote device 103. The functionality called for herein may be executed over multiple devices forming remote device 103 and is not limited to a single device. The specific functionality called for by and present in remote device 103 may be performed on a single device or any combination of devices.

Operation of the present design calls for the computing device to establish and maintain a collection of specialized databases, either based on information collected from prior interactions, known attributes, and information collected by computing devices from a user or users, and employing the information at the computing device to determine psychographic groups and classify or characterize users or potential users as belonging to one or more psychographic groups. The system then seeks to provide information relevant to the particular user, based on her psychographic group or based on attributes known about her, that help facilitate a decision.

Alternately, the present design may include the computing device making a determination of selections being offered and employing the computing device to determine a likely display or arrangement of relevant information that is considered to appeal to users of the site, i.e. users belonging to a known psychographic group. Thus the present design may generally be considered as a computing device employing databases and functional components useful to make a determination on the user side or on the remote side, and seeking to display the selections in a most attractive manner irrespective of how the determination was made. The system may also use a combination of user side and remote side determinations to decide how the selections are preferably displayed.

Psychographic determinations originate from observations from fields including cognitive psychology, anthropology, evolutionary biology, and neurology that many external factors are at work when people make decisions. From a marketing perspective, that is, from the perspective of product marketers wishing to attract and keep customers, many of these factors can be understood and measured through psychographics. Technically speaking, psychographics is the study of personality, values, attitudes, interests, and lifestyles of individuals. The focus on interests, activities, and opinions results in psychographic factors being in some circles called “IAO” variables. Categories of psychographic factors include interests, activities, and opinions (IAOs), attitudes, values, and behavior.

Relatively predictable universal human behaviors affect the process people use to make choices and/or decisions. Such behaviors affect the manner in which people go through the mental process of judging the merits of multiple choices and selecting one choice from among those offered.

Further, certain experiences or preferences are developed in individuals over time. Certain individuals also prefer selections presented in a certain way or using certain language. Persons can be motivated by certain triggers or emotions in making a selection. The present design seeks to implement these realities in a computing device that facilitates a selection beneficial to the user and a party offering the selection and/or selections.

The present design is a system that computationally assesses and employs the psychographic profile of users making online selections. The present design offers a system that either helps users make optimum choices (e.g. select a best situation, pay a least amount of money, etc.), or helps the choices provider maximize its objectives (e.g. maximize sales, maximize profits, minimize losses, etc.), or both.

The present design thus accounts for a psychographic profile of each user and determines a number of selection choices presented to each customer, actionable elements of each selection, wording of the choices (words difficulty, tone of voice, etc.), and/or order in which the choices are presented,

The following is a non-exhaustive list of psychographic elements that can be considered when creating selection choices and/or actions considered when presenting communications to a user:

Agoraphobia—Many people find making choice uncomfortable, and often use procrastination, rules, pre-commitment, habit, suspicion, and imitation to avoid “rational” decision-making and trade. In the present design, the user may be put at ease by providing clear and simple explanations for each selection, such as what the selection means, why the selection is offered, what will happen if that selection is chosen, and how to decide which selection to choose.

“Live to Work”—These users “live to work” so that they can earn monetary rewards and attain higher status. Their goal is to win. This may be a cultural attribute; certain cultures do not “live to work” and such attributes may be rarely found. The system and the choices presented and the psychographic profile may reflect this cultural information.

Newness—Certain persons have a high degree of acceptance for new ideas, innovative products and a willingness to try something new or different, especially as it pertains to technology and business practices. Again, such a psychographic group may have a cultural component—for example, certain cultures may exhibit little willingness to try new ideas. It is to be understood that such cultural attributes are or may be tendencies determined by observation, and may not apply for certain users. For example, a user who works a great deal, i.e. “lives to work,” may be a member of a culture that does not exhibit a “live to work” tendency. Each culture tends to have differences from other cultures, and such attributes may be taken into account. For example, a user seeking goods or services from a European location or internet provider may be believed to exhibit general behavioral tendencies in accordance with persons in the particular country.

Availability Bias—People give preference to information and events that come easily to mind either because they are more recent, were observed personally, and/or were more memorable than other events.

Choices Sequence—People prefer to make quick decisions by picking smaller or simpler choices first, and by choosing sensible default options.

Cognitive Control—People are continually flooded with information about what is rewarding around them—the things they want to do or buy—but also by information about any number of distractions. Such persons have a difficult time attaining a desired goal, especially when time-pressed or tired.

Choice Revision—Having the opportunity to revise one's decisions leaves people less satisfied with the decision outcome.

Ubiquitous Engagement—Millennial consumers, typically born from the early 1980s to early 2000s, tend to prefer engaging with brands on their terms—anytime, anywhere, anyhow.

Endowment Effect (also known as Divestiture Aversion)—People are averse to trading from any given status quo because humans are loss-adverse.

Fear of Choosing—People are afraid of being wrong because they fear the humiliation when making a mistake.

Unpleasantness Avoidance—People are afraid of being unhappy.

Pursuit of Happiness—People are happiest when they have physical pleasure from tasty food, warm environment, etc.; mental engagement (“flow”) from carrying out an enjoyed yet challenging activity; good social relationships; meaning from belonging to something bigger; and a sense of accomplishing tangible goals.

Pursuit of Praise—People enjoy the acceptance and praise of others.

Hyperbolic Discounting—People procrastinate to avoid making uncomfortable choices. Given two similar rewards, humans show a preference for one that arrives sooner rather than later. Humans are said to discount the value of the later reward, by a factor that increases with the length of the delay.

Need to Control—People are born with a deep rooted desire to control matters, including in some cases their environment and other individuals.

Paradox of Choice—Having too many choices can make us less likely to come to a conclusion.

Priming Effect—People's thinking is conditioned by the frequency of their exposure to a word, concept or number.

Quest for Simplicity—In order to act out a change, the activity to be done must be perceived to be simple enough to be within a person's range of ability. Simplicity includes:

Time, Money, Physical Effort, Brain Cycles, Social Deviance, and Non-Routine.

Sociality of Choice—Guidance by Social Networks—People look to their social networks for information, approval, and use accountability in order to limit choice, for mutually beneficial reciprocity, and out of altruism.

Susceptibility to Bargains—People's susceptibility to bargains is one of the cognitive devices they use to simplify choice situations.

Time Pressure—People tend to make decisions faster when there is a deadline for making the choice selection.

Cultural Influences—The needs and drives of those in individualistic societies tend to be more self-centered than those in collectivist societies, focusing on improvement of the self, with self-actualization being the apex of self-improvement. In collectivist societies, the needs of acceptance and community will outweigh the needs for freedom and individuality.

Tone of Voice Response—People react to the tone of voice in the belief that it represents the attitude of the speaker toward them.

The present system thus takes these and possibly other psychographic factors and/or profiles into account in determining a preferential display for the individual user. When a person is, for example, susceptible to bargains, lives to work, and reacts to tones of voices, the system may determine that a simple layout, with less expensive choices displayed first, and an option to hear a description of the product in a soothing voice is called for. Alternately, if a user is determined to have agoraphobic predispositions, desires choice revision capability, and has a need to control, the user may be presented with an ability to make selections and place them in a “cart” or location such that he can easily change his mind, and the user may be notified as much as possible that delivery and returns may be made from the comfort of one's home. Ordering of presentation may not be of particular note in this instance.

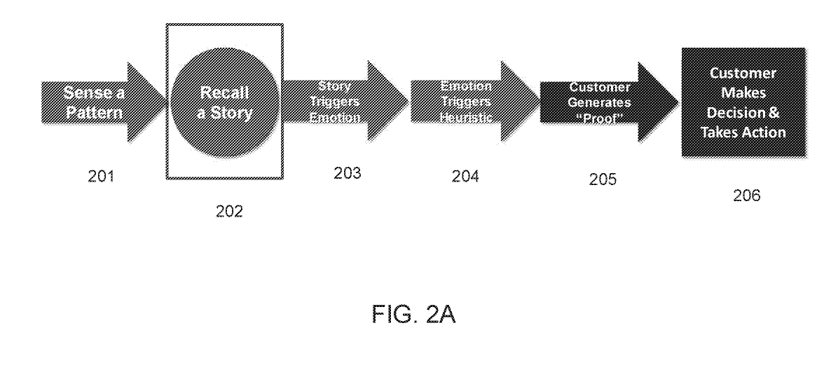

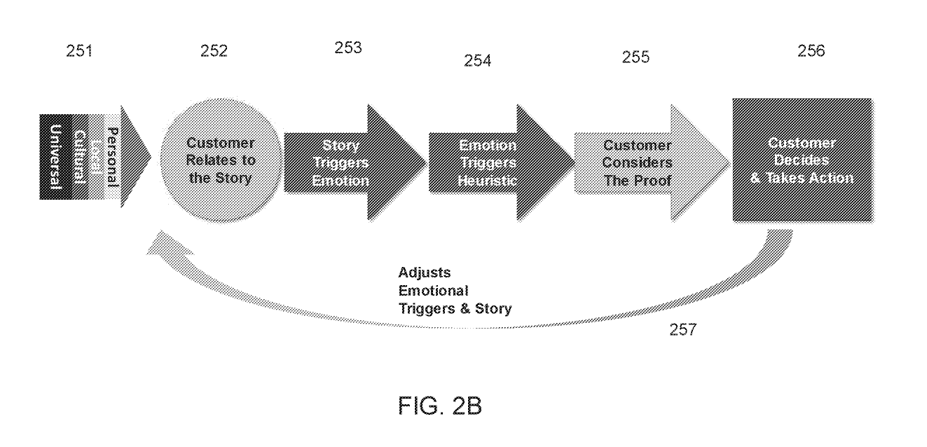

FIG. 2A illustrates the decision making process. From FIG. 2A, the emotions cause an individual to sense a pattern at point 201, recall a story at point 202, the story triggers an emotion at point 203, and the emotion triggers a heuristic at point 204. The logic part of the individual results in the individual generating proof at point 205 and making a decision and taking action at point 206.

FIG. 2B illustrates the overall workflow of the present system. From FIG. 2B, the system assesses the presence of emotional triggers, including personal, local, cultural, and/or universal at point 251. Personal are personal to the user, local are local to the individually, such as geographically, cultural are based on cultural attributes of the user, and universal are universal to all or the vast majority of users. At point 252, the user relates to a particular narrative or story, and the system assesses the user and the situation and determines or offers an appropriate narrative to/for the user. The story presented is calculated to trigger an emotion in the user at point 253 based on his personal, local, cultural, and universal triggers determined by the system at point 251. At point 254, the emotion triggers a heuristic, and at point 255 the system employs the heuristic to determine proof supporting the decision from a specialized database matching heuristics with proof. The system provides proof supporting the decision to the user, and at point 256 the user takes action, such as making a selection. Depending on the results of the interaction between the user and the system, as shown at point 257, the system adjusts emotional triggers and the narrative, either adding points made by the user or deleting points that were not persuasive to the user.

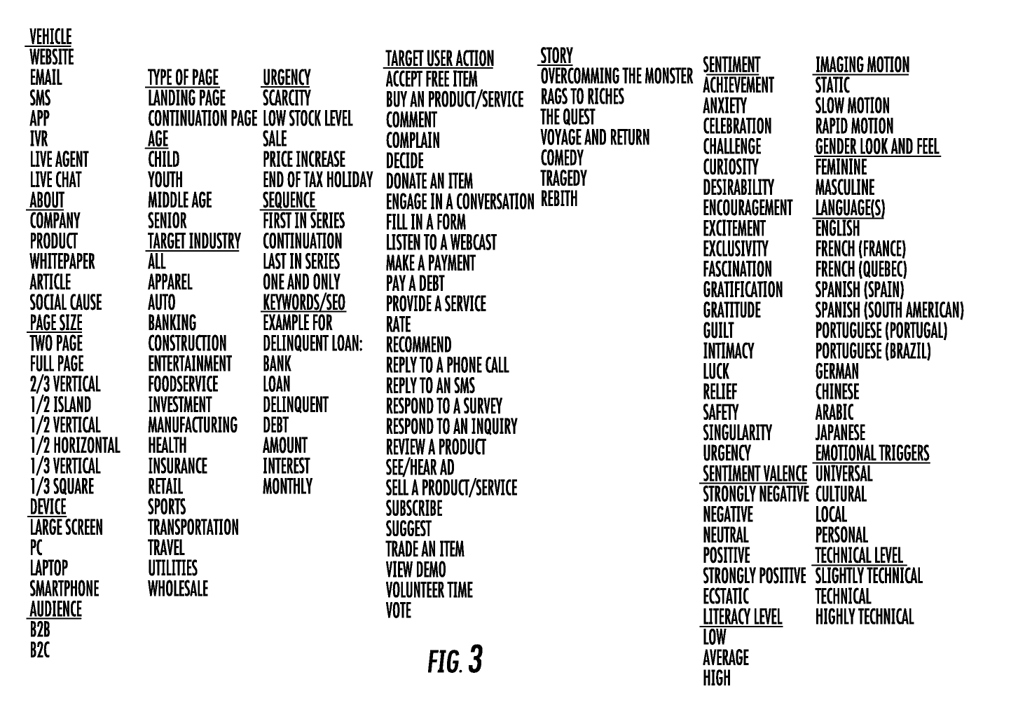

FIG. 3 illustrates a number of elements collected and classified by the system and used to produce an interaction with a user tailored to the specific situation. In general, on the left of FIG. 3 are practical considerations evaluated by the system, including the vehicle of communication, subject of the communication, device employed by the user, age of the user, urgency of the communication, sequence of the communication (first interaction, continuation of ongoing dialog, etc.), and keywords relating to the transaction. In the situation where the user is contacting the computing device to address a delinquent loan, keywords that are processed by the computing system include “bank” “loan” “debt” and so forth. If the user mentions these words, they may be used by the computing device to formulate a response, and these words may be avoided if, for example, the user has expressed or demonstrated sensitivity to the words, such as by stopping a communication when a particular word had been used in the past. Such a word would be considered a “trigger” word and the system saves the trigger word to the trigger database described below. In the center of FIG. 3 is a series of target user actions, i.e. what the user can do, or the action she can take, as well as the actions that the system seeks to influence the user to take. On the right of FIG. 3 is a set of various emotional attributes, as well as narrative attributes (comedy, tragedy, rebirth, etc.), as well as sentiments, sentiment valence, emotional triggers, technical level, and so forth.

All of the elements in FIG. 3 represent either categories or choices, where categories include categories of information relevant to various situations. The respective database for the category may include relevant entries. For example, if a “comedy” narrative is called for, a comedic story may be maintained in a database and employed, via formatting and placement of phrases or images, in a collection of persuasive information to the user. As may be appreciated from the various categories and elements in FIG. 3, certain information may be collected from or about the user, either from available information or information provided by the user and collected at the computing device, or based on the situation presented.

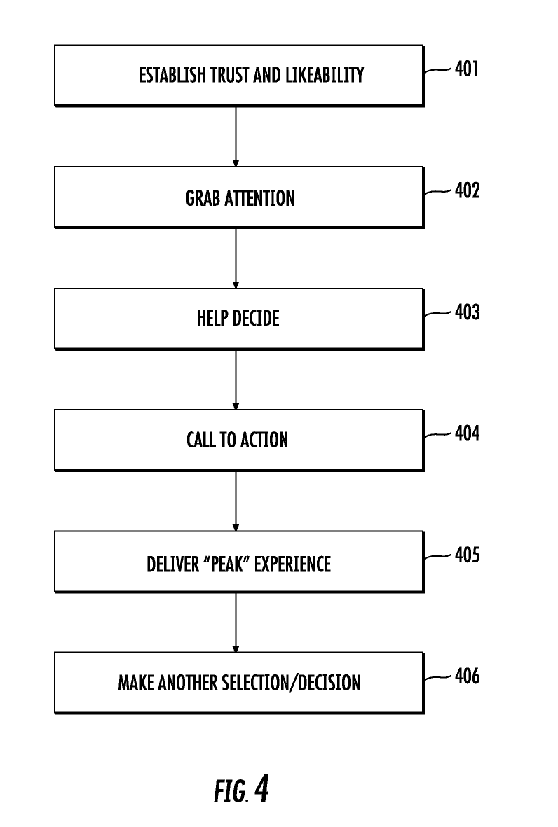

FIG. 4 illustrates actions taken by the computing device or system to facilitate the decision of the user. At point 401, the system provides communications seeking to establish trust and likeability. Examples include company branding, where the user is guided to trust the selection provider because of its history and reputation. Alternately, the company tagline or motto may be presented, or evidence demonstrating the selection provider's passion about service. A graphic may be presented, a “hero banner,” demonstrating that the selection provider is likeable and/or trustworthy.

Point 402 is an element provided by the system seeking to “grab the attention” of the user. Certain phrasing or graphics may be provided and employed depending on the personal, local, cultural, and/or universal triggers of the user. The system at point 403 determines information and provides information determined, based on the user and the user profile created, assists the user in making a decision. Examples provided include providing a description of the “pain” felt by the user and a suggested solution, prove the existence of “pain” via a third party endorsement, elaborate on “pain” or problems with real life stories, showing that a particular entity can be trusted to solve the pain as demonstrated by a third party endorsement, a demonstration as to how the selection removes the “pain,” and how certain Actions from the Action Set can and will be beneficial to the user, i.e. a value proposition.

The system may determine and provide a call to action to the user at point 404. In the call to action, a number of options may be determined and provided to the user. One option is reciprocity, giving the user something for free before taking the Action, a call to action, inviting the user to take one Action from the Action set, simplicity, wherein information is provided to the user that shows how easy it is to take the Action, objections where the system determines predicted objections and answers such objections or conveys information answering the objections, potentially based on universal, cultural, etc. attributes, and urgency, wherein the system provides indications of urgency to take a particular Action or Actions. For example, if the user is deciding whether to consult with a doctor and which doctor to consult, the system may have this information (decision being made by the user as to whether to consult a doctor and which doctor to consult), and the system may determine that Doctor J is going to be unavailable for the next three weeks, and may convey this “urgency” information to the user.

A second simplicity call to action may be determined by the computing system and offered in cases where further simplicity would be beneficial. For example, if the user was persuaded by simplicity information previously conveyed and the system determines further simplicity information would be helpful, such information may be conveyed. A second call to action may also be determined by the computing device and offered, for the user to take an Action from the Actions set.

As may be appreciated from the present description, communications, data, information, Actions, and so forth may occur over time, and may be part of an ongoing exchange via chat, email, web site communications, or any other communication means known and available. For example, the system would not offer the same simplicity call to action communication within a short period of time, as offering the same thing may frustrate a user, but if a simplicity call to action is beneficial during one communication with the user and the system determines the same or a different simplicity call to action would be beneficial later in the communication or during a second communication, such a simplicity call to action may be determined and presented to the user.

The call to action 404 may also include a bonus to entice the user to take an Action, a guarantee, such as a guarantee of satisfaction, and/or other determinations that may enhance the user's experience and/or that is determined to facilitate the user taking a particular action, e.g. determining and providing information that enhances the user's experience.

Point 405 constitutes the computing device determining that a beneficial or peak experience has been provided to the user, including confirming that an Action was completed successfully and the “pain” has been removed. Alternately, the system may determine that conveying positive feedback, such as congratulating the user for removing the pain may be transmitted to the user.

Point 406 offers the user the ability to make another selection or decision, such as another Action to remove another “pain” or problem situation. Further communications and/or options may be provided depending on circumstances. For example, a user may resolve an issue quickly or may need several communications to resolve the issue.

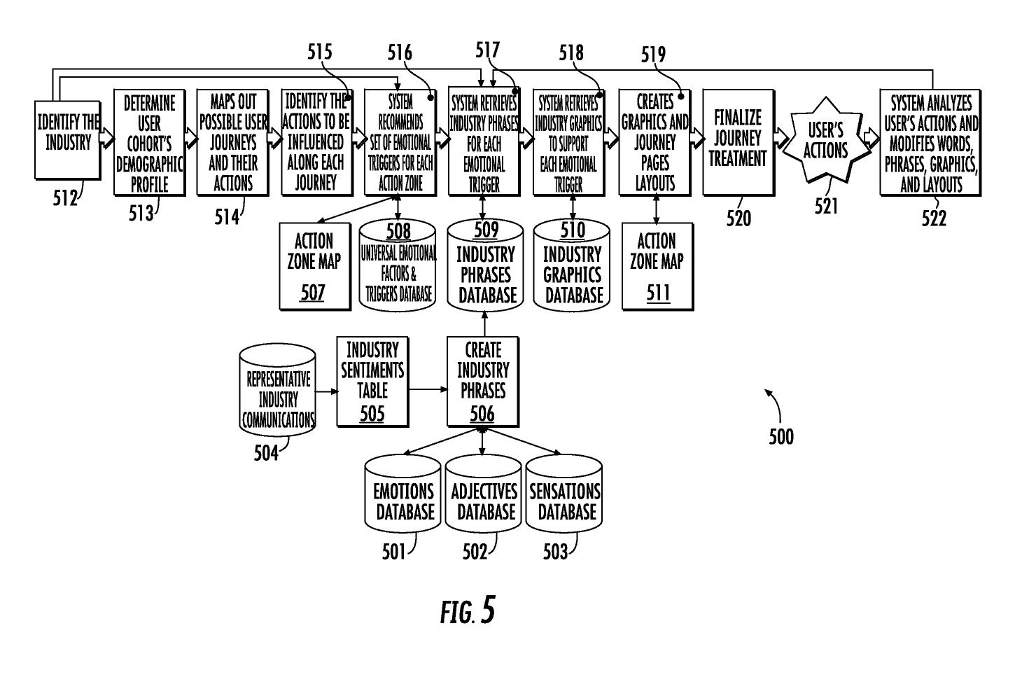

FIG. 5 illustrates an overview embodiment of the operation and components of the current system 500. Databases such as emotions database 501, adjectives database 502, and sensations database 503 are provided and include, respectively, emotion language, adjectives, and sensations language. Database 504 provides representative industry communications applicable to the various industries using the system 500, and this database is accessed by the industry sentiments table 505 to create a table of sentiments, such as collections of phrases applicable to the particular industry, including industry communications pertinent to various users. As an example, an industry may communicate using email and database 504 may include communication templates, graphics, and so forth, while industry sentiments table 505 takes this information and creates sentiments related to the industry, such as users may be “excited,” “anxious” “challenged,” and so forth applicable to the particular industry. The system process the information from industry sentiments table 505 and the emotions, adjectives, and sensations from databases 501, 502, and 503, to create industry phrases that may be used in communications. For example, attention getting questions may be provided to a user who is interested in achievement such as “Are you doing everything you can to get ahead at your job?”

Point 512 is the device identifying the industry based on the information provided, such as the user and the decision being made. This processing can be done without having contacted the user but with the intent of contacting the user. If the user is a job seeker in the retail field, the retail field may be identified for the user based on a questionnaire answered, information gathered from a web site or sites, or in any other way. Point 513 represents the system determining the user cohort's demographic profile, e.g., this person is a job seeker and thus the system locates and/or identifies and/or employs a profile for job seekers. Further information may be available (e.g. college graduate job seeker, executive job seeker, job seeker in a particular geographic area, etc.) At point 514, the system maps out a number of possible user journeys and the associated Actions. For example, in the job seeking realm, contacting various employers, interviewing, following up with the employers, contacting friends, networking on social media, etc. At point 515, the system identifies actions to be used along the journey, such as emails to check up on the user's progress, providing supporting communications if appropriate, providing queries as to status where appropriate, and so forth. These determinations made by the processor may be made based on the particular industry and/or entity input, history observed with decisions previously made, and other relevant information collected. For example, Actions may change depending on circumstances and input received. Points 512-515 may be provided by the system or by operator selection.

Point 516 recommends a set of emotional triggers, relevant to the industry, for each Action zone. For example, in the job seeking scenario, the journey may include identifying relevant potential employers, sending communications to those relevant employers, following up, scheduling interviews when offered, interviewing, following up on interviews, and so forth, with each of these being a potential Action, and the system at point 516 identifies and may recommend or suggest a set of emotional triggers for the relevant actions, such as slightly applying pressure (“Have you called prospective employer X?” “Have you decided what you are going to wear to your interview on Wednesday?”), encouragement (“You scheduled your first interview! That is great!”) or other emotional trigger appropriate as determined by past history and the system. Again, these triggers may be industry specific. As shown in FIG. 5, database 508 is the universal emotional factors and triggers database that maintains universal emotional factors and triggers, i.e. factors and triggers applicable to all people, and element 507 is an Action zone map, wherein the Action map decided, such as at points 514, 515, and 516, may be, for example, (1) research potential employers, (2) identify potential employers, (3) determine how to best contact potential employers, and so forth, and this is provided to and updated and/or changed by the system in connection with element 516. In other words, the Action map is established, the system saves the Action map at point 507, and the system determines emotional triggers for the various Action zones in the Action map.

At point 517, the system retrieves industry phrases for each emotional trigger, based on industry phrases from industry phrases database 509, developed from industry phrases created by the system at point 506, again using the industry sentiments table 505 and the three databases 501, 502, and 503. Industry phrases are specific to the industry, setting, or milieu, such as technology, job seeking, etc. In the technology area, when deciding between two designs, point 517 may provide industry phrases relevant to an emotional trigger based on the Action zone map provided, such as gently applying pressure (“Shouldn't you start beta testing Design A before the end of the quarter?”) or encouragement (“You secured funding to develop the selected design! That is fantastic!”) or inquisitive (“What is it about the circuit layout of Design B that you find favorable?”) Again, point 517, like point 516, receives the specific industry and the system retrieves the appropriate information for that industry, setting, or milieu.

At point 518, the system retrieves industry specific graphics, as appropriate, supporting each emotional trigger. Upbeat communications may include graphics such as fireworks, etc., while low key and calming communications may include soft pictures of friendly faces, for example. An industry graphics database 510 collects graphics appropriate for each relevant industry, setting, or milieu, and the system at point 518 retrieves the industry graphics appropriate for the situation. At point 519, the system creates graphics and journey communication layouts, taken from templates or other graphical standards, and may provide these in any acceptable form (web page, email, text, video, and so forth. The system may use the Action zone map 511, which may be the same as Action zone map 507 in one embodiment. Thus based on the Action zone map, emotional triggers, industry phrases, industry graphics, and so forth, a coherent communication, such as a web page including situation appropriate graphics, text, and message, can be conveyed to the user to facilitate the user making a decision.

As may be appreciated, the system 500 may operate to guide the user to a desired result, such as by offering selected emotional triggers and communications guiding the user in a desired direction, such as selecting design option B from among three options being considered. With the Action mapping and emotional triggers, the user may be guided, but not necessarily mandated, to reach a conclusion or decision desired in the industry, setting, or milieu.

At point 520, the system may finalize the journey treatment, including all relevant information relating to the decision seeking campaign or Action plan. At point 521, the user takes desired Actions, receiving the communications as called for in the Action plan, and acting as desired. At point 522, the system analyzes the user's actions, including taking Actions provided according to the established Action zone map and/or Actions expressly not taken according to the Action zone map, and analyzes these for success, failure, indifference, etc., and may report this information and/or provide the results of such analysis to the system to modify communications, including but not limited to words, phrases, graphics, layouts, triggers, and other relevant factors. Such feedback provides for continuous multivariate testing and enhancement of the psychographic decision making technique.

The particular attributes of the elements of FIG. 5, including the demographic of the user, particular cohort of the user, user journey and Actions, actions influenced along the Journey, and so forth may be established either based on information known about the user and the situation (industry, emotional triggers, etc.) or may be entered into the system in an acceptable manner.

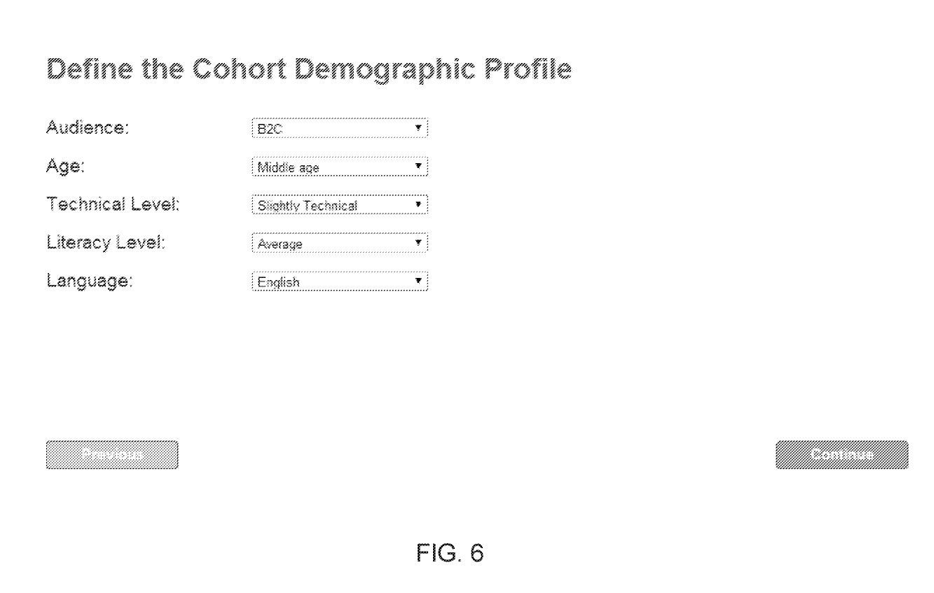

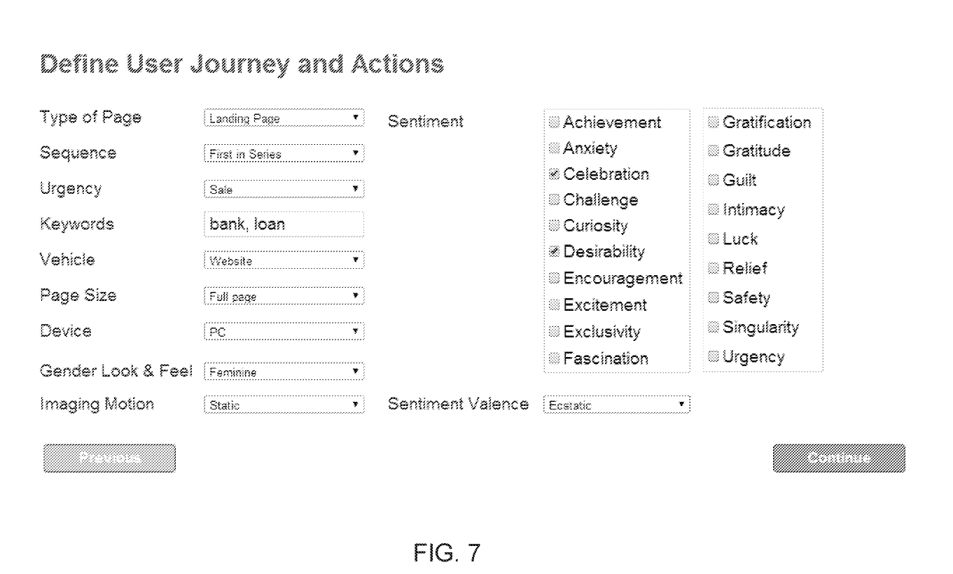

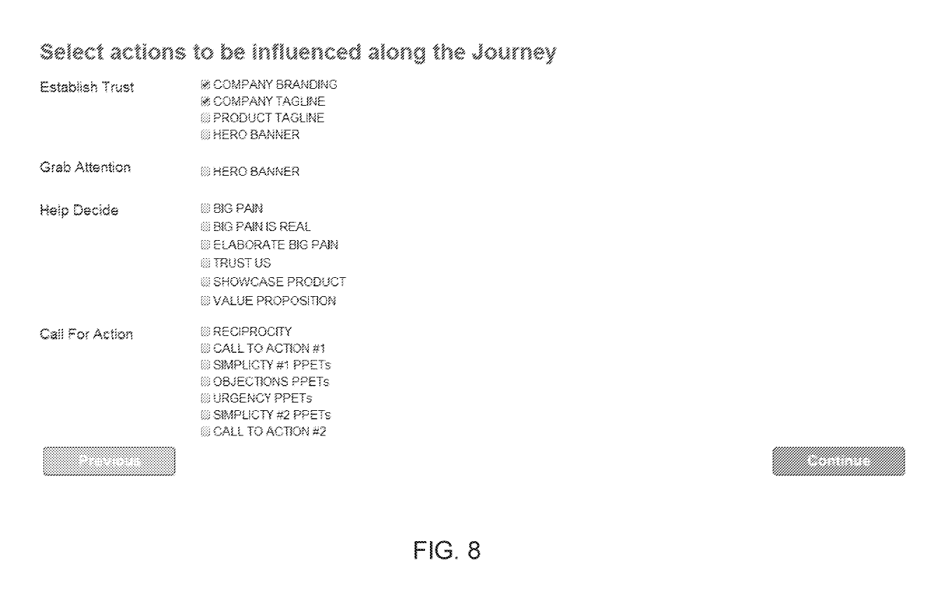

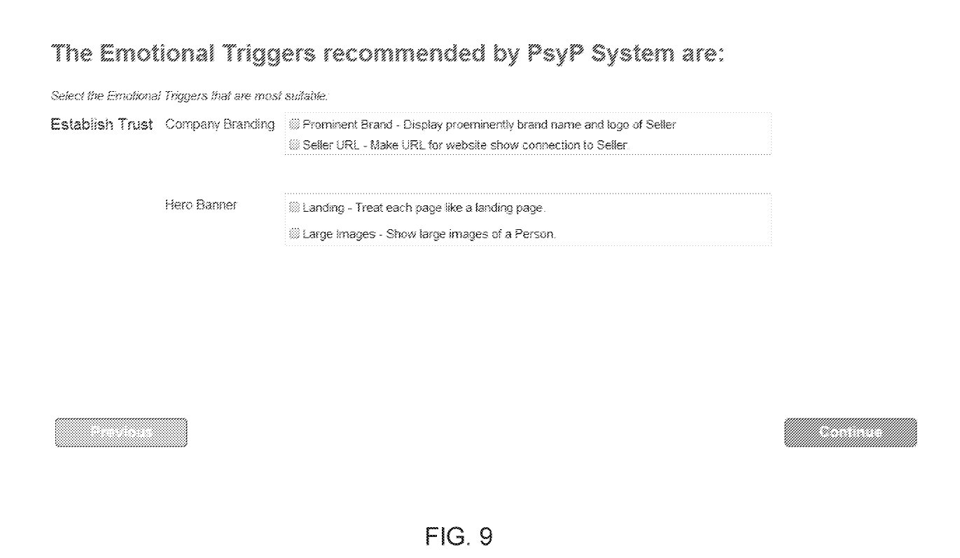

One such representative screen may include selection of the target industry, situation, or milieu. FIGS. 6-11 illustrate various input parameters and certain selections in one embodiment of the present system, typically representing sample screens used for accumulation of information for the situation presented. FIG. 6 illustrates the Cohort Demographic Profile selection (middle age, average literacy, etc.), while FIG. 7 shows selections for User Journey and Actions, including keywords (bank, loan), a vehicle for communication that is preferred (website), sentiment (celebration and desirability) and sentiment valence (ecstatic). FIG. 8 shows actions to be influenced along the journey, including in areas such as Establish Trust, Grab Attention, Help Decide, Call for Action, where Establish Trust includes Company Branding and Company Tagline. FIG. 9 illustrates recommended emotional triggers and may be determined by the system or selected, including the category of Establishing Trust, with Company Branding and a Hero Banner. For the Hero Banner, the system offers a Landing Hero Banner that treats each page like a landing page or Large Images, showing large images of a person. Either, neither, or both may be selected. If none is selected, a default may be provided, where the default may include one selection or a blank page, for example.

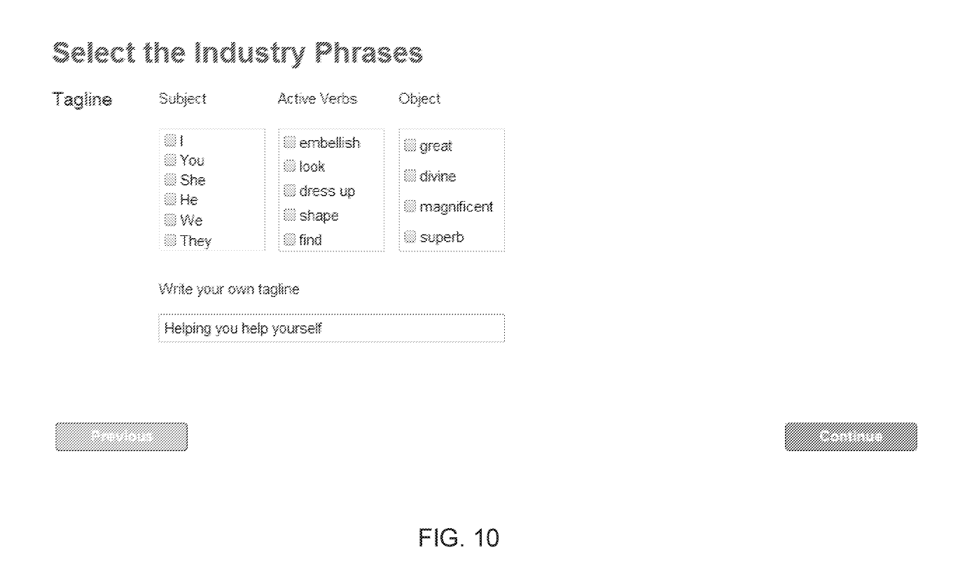

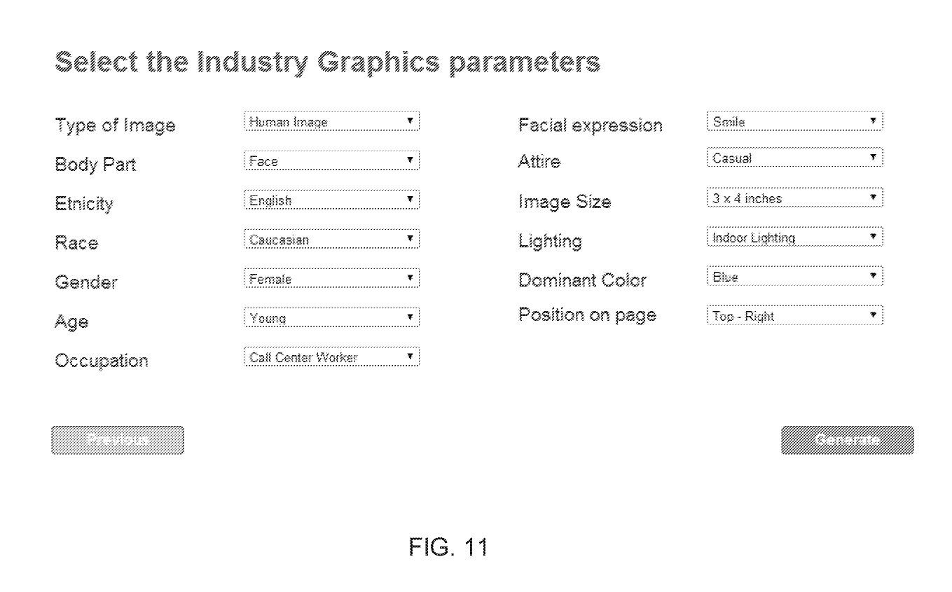

FIG. 10 enables selection of industry phrases. In this example, tagline options are offered including subject, active verbs, and objects relevant to the industry, situation, or milieu. Alternately a tagline can be provided. FIG. 11 shows industry graphics parameters to be used in the campaign or journey, including parameters such as occupation (call center worker), facial expression (smile), attire (casual) dominant color, and image size and position.

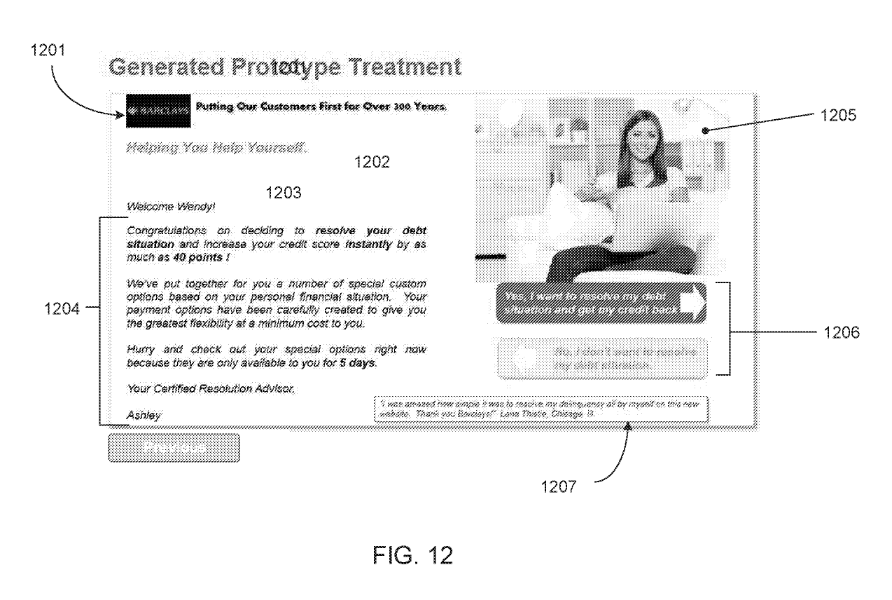

Having established the foregoing, and as shown in FIG. 5 having established the Action zone map, emotional triggers, industry phrases, industry graphics, page layouts, and so forth, the system assembles the communication for display to the user. FIG. 12 is an example communication, in this case a web page, including company branding 1201, a tagline 1202, a salutation 1203, text 1204 pertinent to the situation and user based on the Action, triggers, and so forth, a graphic 1205 appropriate to the industry and situation, and a call to action 1206 in the form of two selections. Finally, a recommendation 1207 is provided, determined by the system to be appropriate in this situation.

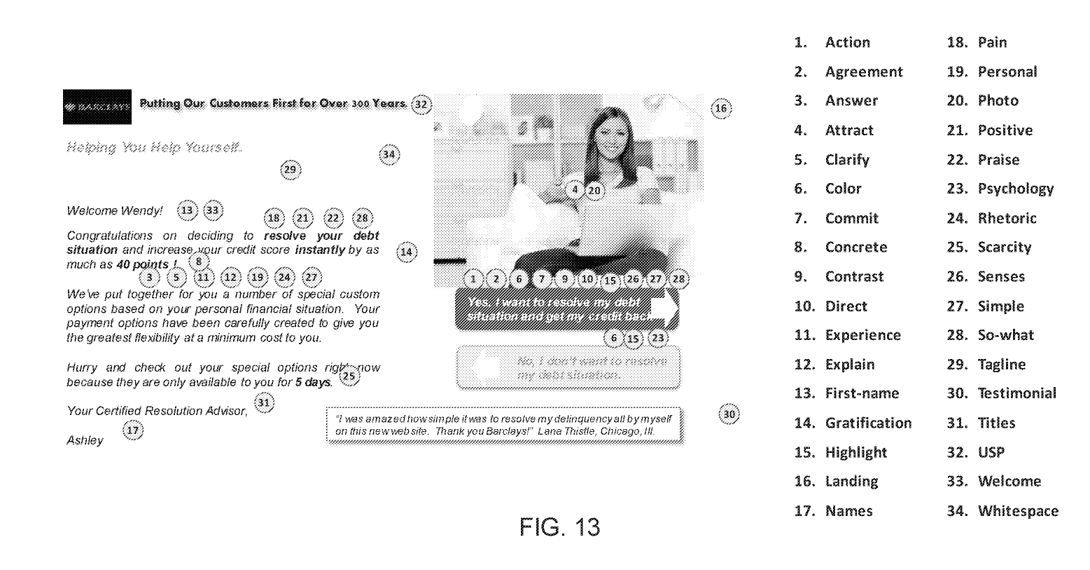

FIG. 13 shows the breakdowns of all components determined for the situation and included in the communication provided. The communication 1301 presented on the left includes the psychographic persuasive triggers and emotional triggers on the right. As an example, at the lower right of the communication is a testimonial, while at the upper left is the USP—unique selling proposition. In practice, the system accounts for the user and determines, for that user and that communication (part of that Action plan) the specific graphics, testimonials, text, and so forth. Hence the system determines a unique communication for the user and the particular situation, and it would not be unusual for no two communications to be identical.

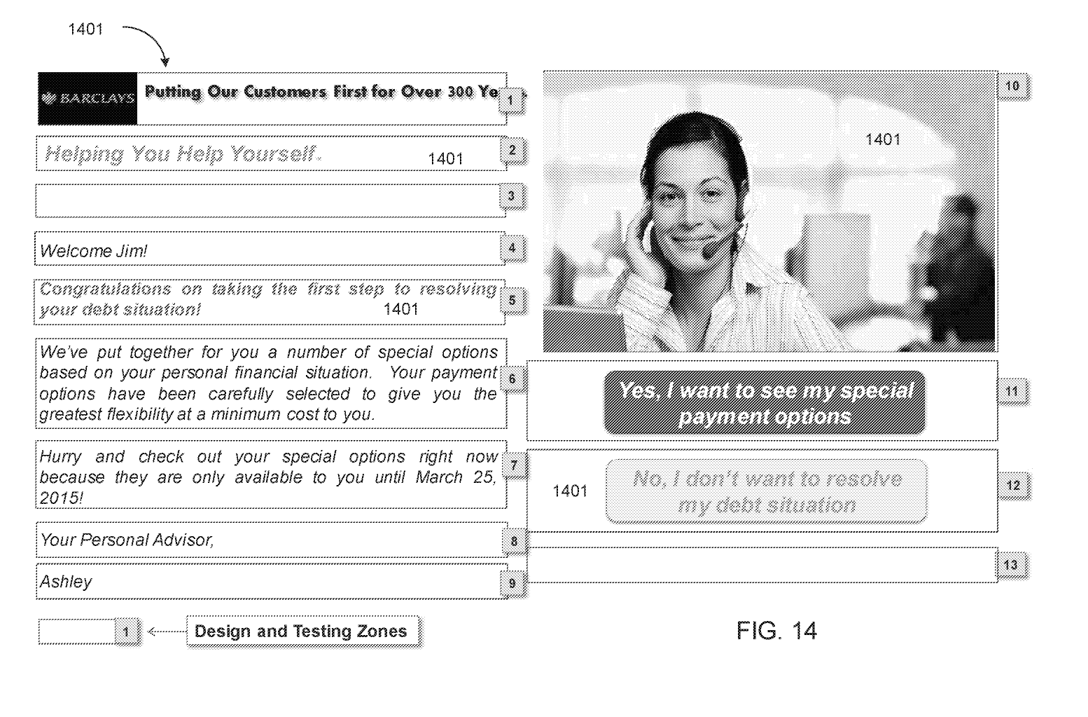

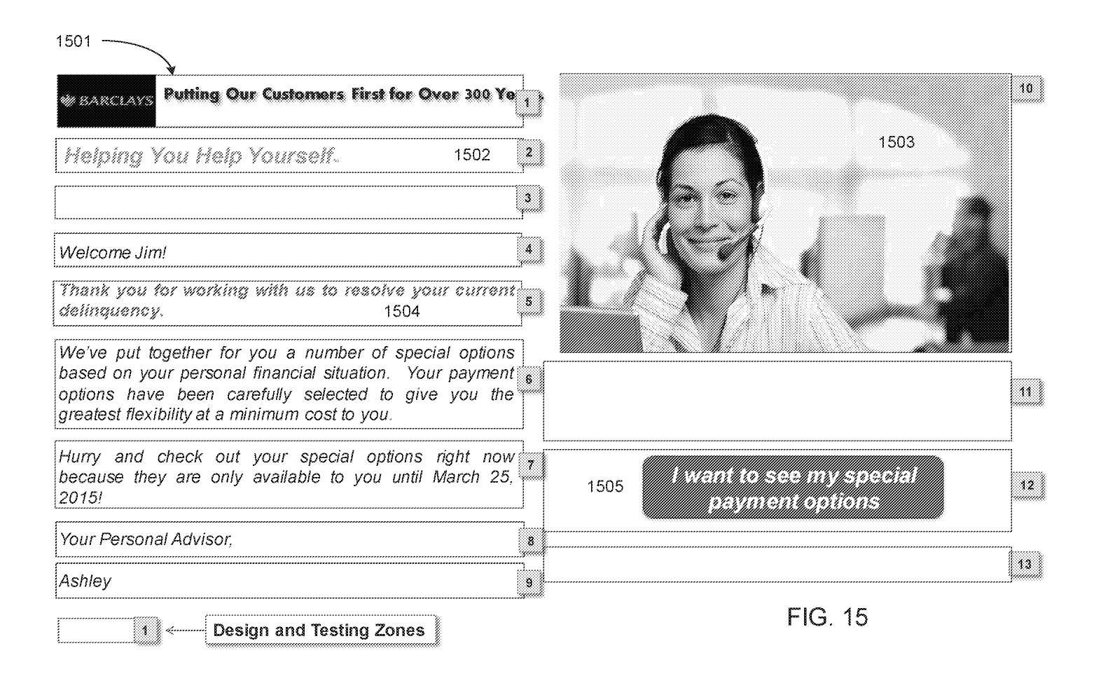

FIGS. 14 and 15 show two different treatments for similar situations. FIG. 14 shows a first treatment 1400 including the company name 1401 and slogan 1402, a graphic 1403, and a number of text presentations. In particular text sections 1404 (congratulations) and 1405 (negative response action text) are presented. FIG. 15 shows identical components company name 1501, slogan 1502, graphic 1503, but includes a different text section 1504 saying “Thank you . . . ” rather than “Congratulations . . . ” and a slightly different call to action 1505 Further, no negative response action text is provided in this treatment. The two treatments of FIGS. 14 and 15 may be used for the same person under different conditions (e.g. depending on whether the user has an emotional trigger of being congratulated as opposed to being thanked), and may include or omit the possibility to refuse to take action. Omitting the ability to take action may be employed where it is determined most people offered a negative option select such an option, as opposed to persons receiving only a positive option selecting the option and more rapidly or successfully make a decision. Thus both factors individual to the user and relevant to the situation, general population, or even the industry, situation, or milieu may be considered and employed by the system to determine content of the communication.

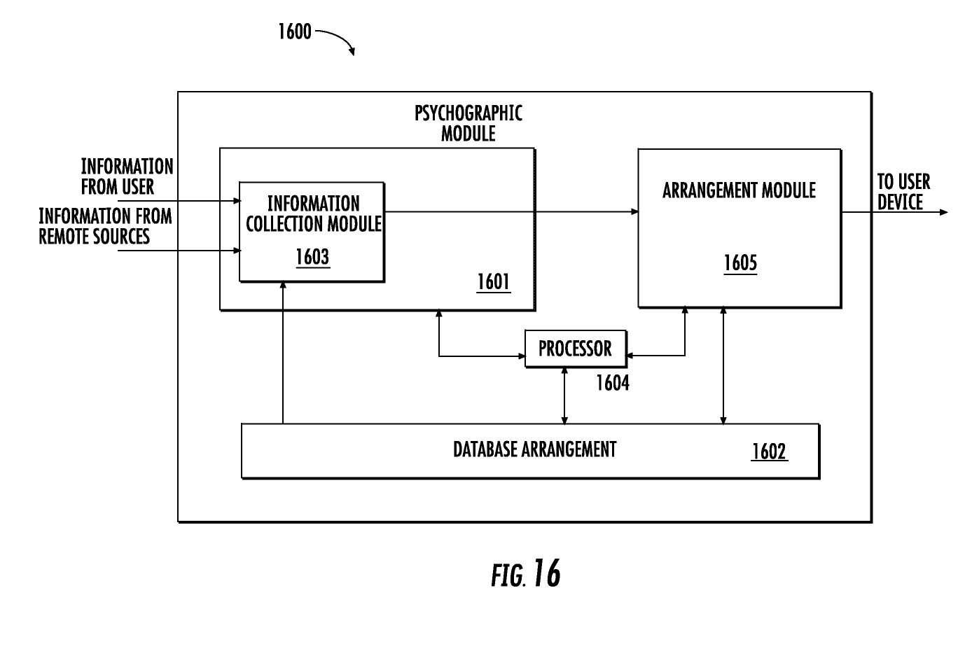

FIG. 16 shows an alternate representation of the present system 1600. The system 1600 may include a psychographic module 1601. The psychographic module 1601 may receive information from the user via the user device, from the history for the particular user available to the remote device, such as from a database arrangement 1602 as shown in FIG. 16, and/or from any remote sources. Psychographic module 1601 includes an information collection module 1603 that collects the information, a processor 1604 that processes all available information about the user relative to the user and the situation (triggers, personal situations, demographic group(s), etc.) The processor determines the communication or communications for the situation, based on the Action zone map, emotional triggers, industry phrases, industry graphics, and other materials or information shown in FIG. 5, and passes the materials relevant to the communication (templates, wording, graphics, etc.) to the arrangement module 1605, also connected to the processor 1604, and arrangement module arranges the relevant components of the communication and determines how and under what conditions the communication is to be transmitted to the user.

Thus the present design includes a system useful in a provider serving electronic communications facilitating decision making by a user. The system comprises a computer store arrangement containing emotional wording, adjectives, sensations, industry phrases, industry communications, industry graphics data, and universal emotional factors and triggers usable for inclusion in at least one electronic communication (i) wherein the at least one electronic communication is configured to include text and graphics using an electronic communication template; and (ii) wherein the at least one electronic communication includes at least one call for action to be taken by the user selectable by the user to facilitate the user making a decision. The system further includes a computer processor coupled to the computer store and programmed to: (i) receive a profile of the user's demographic profile; (ii) map out possible user journeys and actions; (iii) identify actions to be influenced along each journey; (iv) determine a set of emotional triggers for each action; (v) retrieve industry phrases and industry graphics for each emotional trigger; and (vi) create graphics and journey page layouts. The computer processor transmits the graphics and journey page layouts created by the computer processor in the at least one electronic communication.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A system useful in a provider serving electronic communications facilitating decision making by a user, the system comprising:
a computer store arrangement containing emotional wording, adjectives, sensations, industry phrases, industry communications, industry graphics data, and universal emotional factors and triggers usable for inclusion in at least one electronic communication (i) wherein the at least one electronic communication is configured to include text and graphics using an electronic communication template; and (ii) wherein the at least one electronic communication includes at least one call for action to be taken by the user selectable by the user to facilitate the user making a decision; and
a computer processor coupled to the computer store and programmed to: (i) receive a profile of the user's demographic profile; (ii) map out possible user journeys and actions; (iii) identify actions to be influenced along each journey; (iv) determine a set of emotional triggers for each action; (v) retrieve industry phrases and industry graphics for each emotional trigger; and (vi) create graphics and journey page layouts;
wherein the computer processor transmits the graphics and journey page layouts created by the computer processor in the at least one electronic communication.

2. A system useful in a provider serving electronic communications facilitating decision making by a user, the system comprising:
a processor;
a storage device having a first database configured for storing emotional factors and triggers categorized according to demographic profiles of users; a second database configured for storing industry phrases comprising emotions, adjectives and sensations selected based on industry sentiments extracted from representative industry communications; a third database configured for storing industry graphics;
a computer code module programmed to cause the processor to identify an industry associated with a user;
a computer code module programmed to cause the processor to determine a demographic profile of the user;
a computer code module programmed to cause the processor identify actions to be influenced and create an action zone map having a plurality of actions;
a computer code module programmed to cause the processor to recommend a set of emotional triggers selected from the first database and associate the emotional triggers for each of the plurality of actions in the action zone map;
a computer code module programmed to cause the processor to retrieve industry phrases from the second database for each emotional trigger recommended;
a computer code module programmed to cause the processor to retrieve industry graphics from the third database to support each emotional trigger recommended; and
a computer code module programmed to cause the processor to create a page layout comprising the industry phrases and graphics previously retrieved according to the action zone map;
whereby the processor transmits the page layout created by processor in an electronic communication to the user.

3. The system of claim 2, wherein the actions comprising the action zone map comprise communications seeking to establish trust and likeability, communications seeking to grab the attention of the user, communications seeking to call to action the user, communications seeking to deliver a peak experience to the user, and communications seeking to persuade the user to make another decision.

4. The system of claim 2, wherein the storage device comprises a fourth database configured for storing industry communications applicable to the industry, the fourth database including an industry sentiments table comprising collections of phrases applicable to the industry.

5. The system of claim 4, wherein the storage device further comprises a fifth database configured for storing emotional categories, the fifth database cross-referenced with the industry sentiments table categorizing the collections of phrases by emotion.

6. The system of claim 4, wherein the storage device further comprises a sixth database configured for storing adjectives, the sixth database cross-referenced with the industry sentiments table categorizing the collections of phrases by adjectives.

7. The system of claim 4, wherein the storage device further comprises a seventh database configured for storing sensations, the seventh database cross-referenced with the industry sentiments table categorizing the collections of phrases by sensations.

8. The system of claim 2, wherein the a computer code module programmed to cause the processor to determine a demographic profile of the user identifies psychographic factors of the user as belonging to one or more psychographic groups.

9. The system of claim 2, further comprising a computer code module programmed to cause the processor to analyze any actions taken by the user in response to the electronic communication transmitted to the user.

10. The system of claim 9, wherein the analyses of the user's actions in response to the electronic communication influence and modify future electronic communications generated by the processor.

11. The system of claim 2, wherein the electronic communication is selected from the group consisting essentially of website, email, SMS, app, IVR, live agent, and live chat.
